(19) United States
(12) Patent Application Publication
(10) Pub. No.: US 2023/0111743 A1
(43) Pub. Date: Apr. 13, 2023

(54) Hand Tool with a Cutting Function

(71) Applicant: Hanlong Industrial Co., Ltd., New Taipei City 236 (TW)

(72) Inventor: Pai-Wei Lin, New Taipei City (TW)

(21) Appl. No.: 17/565,665

(22) Filed: Dec. 30, 2021

(30) Foreign Application Priority Data
Oct. 8, 2021 (TW) 110211911

(51) Int. Cl. B25B 7/22; B26B 13/22

(52) U.S. Cl. CPC B25B 7/22; B26B 13/22

(57) ABSTRACT

A hand tool with a cutting function is disclosed. The hand tool is used for cutting a wire. The hand tool includes a first body, a second body, a first plier, a second plier, a pivoting piece, a blade, and a knife drill. The second body is arranged symmetrically with the first body. The second plier is arranged symmetrically with the first plier. The pivoting piece is simultaneously pivotally connected to the first body, the second body, the first plier, and the second plier. The knife drill corresponds to the blade, and the blade and the knife drill are respectively arranged on the first body or the first plier such that, when the first plier and the second plier are pressed, the blade approaches the knife drill so as to cut the wire.

### BACKGROUND OF THE INVENTION

### Field of the Invention

The present invention relates to a hand tool with a cutting function, and more particularly to a hand tool having a stripping function and a cutting function simultaneously.

### Description of the Related Art

In the prior art of the wire stripping method of coaxial cable or round telephone wire, etc., commonly used methods include direct cutting with a blade or using needle-nose pliers to strip the insulation outside the wire. However, in the prior art, the wire stripper must use scissors to cut the insulation layer after stripping the wire. If the wire stripping fails, the wire must be cut with scissors. Therefore, when the user uses a wire stripper, the user often needs to use scissors. However, carrying and operating two hand tools at the same time may be difficult and inconvenient for the user.

Therefore, it is necessary to invent a new hand tool with a cutting function to mitigate and/or obviate the aforementioned problems.

### SUMMARY OF THE INVENTION

It is a primary object of the present invention to provide a hand tool with a cutting function that also has a stripping function.

To achieve the above objective, a hand tool with a cutting function of the present invention is used for cutting a wire. The hand tool with a cutting function comprises a first body, a second body, a first plier, a second plier, a pivoting piece, a blade, and a knife drill. The second body is arranged symmetrically with the first body. The second plier is arranged symmetrically with the first plier. The pivoting piece is simultaneously pivotally connected to the first body, the second body, the first plier, and the second plier. The knife drill corresponds to the blade, and the blade and the knife drill are respectively arranged on the first body or the first plier such that, when the first plier and the second plier are pressed, the blade approaches the knife drill so as to cut the wire.

### BRIEF DESCRIPTION OF THE DRAWINGS

FIG. 1 illustrates a three-dimensional schematic diagram of the hand tool with a cutting function of the present invention.

FIG. 2 illustrates an exploded schematic diagram of the hand tool with a cutting function of the present invention.

FIGS. 3A and 3B illustrate schematic diagrams of the continuous motion of the hand tool with a cutting function of the present invention.

### DETAILED DESCRIPTION OF THE PREFERRED EMBODIMENTS

The advantages and innovative features of the invention will become more apparent from the following detailed descriptions when taken in conjunction with the accompanying drawings.

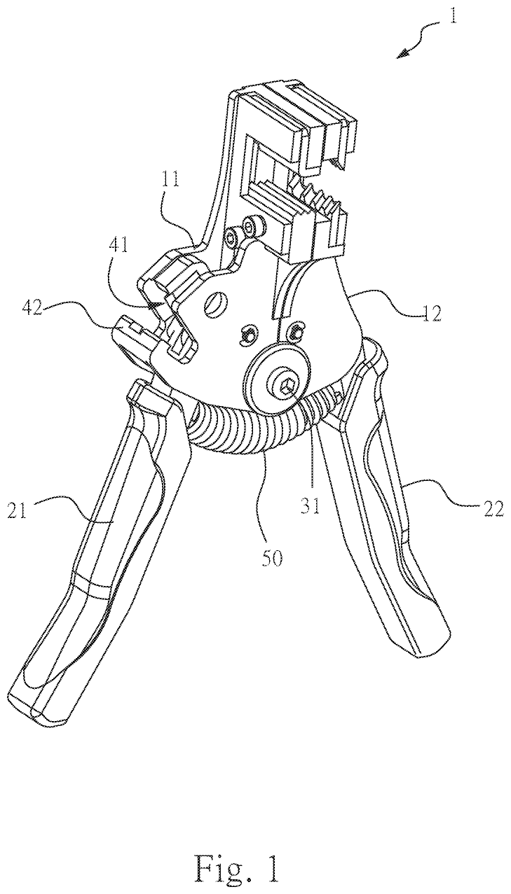

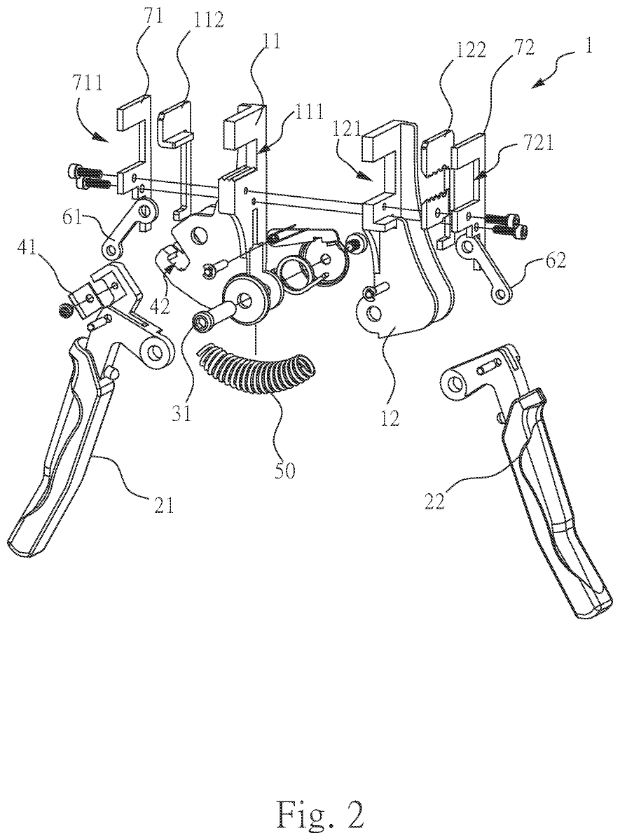

Hereafter, please refer to FIG. 1, which illustrates a three-dimensional schematic diagram of the hand tool with a cutting function of the present invention, and FIG. 2, which illustrates an exploded schematic diagram of the hand tool with a cutting function of the present invention.

The present invention provides a hand tool 1 with a cutting function, and the hand tool 1 also has a wire stripping function. It should be noted that, although the terms “first” and “second” are used to describe the elements, the elements are not limited by such terms. The terms are for merely differentiating one element from another element. For example, without departing from the scope of the described embodiments, a first body can be referred to as a second body, and a second body can be similarly referred to as a first body. The first body and the second body are both bodies but are not the same body.

In an embodiment of the present invention, the hand tool 1 comprises a first body 11, a second body 12, a first plier 21, a second plier 22, a pivoting piece 31, a blade 41, and a knife drill 42. The first body 11 is arranged symmetrically with the second body 12. The first body 11 is provided with a first jaw section 111, and the second body 12 is provided with a second jaw section 121. The first jaw section 111 is also arranged symmetrically with the second jaw section 121. In the embodiment of the present invention, the surface of the first a section 111 may be jagged. The first plier 21 and the second plier 22 are also symmetrically arranged for the user to hold.

The first plier 21, the second plier 22, the first body 11 and the second body 12 are jointly pivoted by the pivoting piece 31 such that the first plier 21 and the second plier 22 can rotate relatively. However, when the first plier 21 and the second plier 22 are rotated, the first body 11 and the second body 12 will not rotate together.

The blade 41 and the knife drill 42 are respectively arranged on the first plier 21 or the first body 11. In one embodiment of the present invention, the blade 41 is arranged on an outside of the first plier 21, and the knife drill 42 is located on the first body 11 and corresponds to the blade 41. As shown in FIG. 1, the blade 41 is arranged on the first plier 21 on the left side, and the knife drill 42 is arranged on the first body 11 on the left side, but the present invention is not limited thereto. The blade 41 can be arranged on the first body 11. and the knife drill 42 can be arranged on the outside of the first plier 21. Alternatively, the blade 41 can be arranged on the second plier 22 on the right side, and the knife drill 42 can be arranged corresponding to the second body 12 on the right side, and so on for different settings. The hand tool 1 of the present invention further comprises a compression spring 50. One end of the compression spring 50 is connected to the first plier 21 and another end of the compression spring 50 is connected to the second plier 22 such that the first plier 21 and the second plier 22 will be separated when no force is applied.

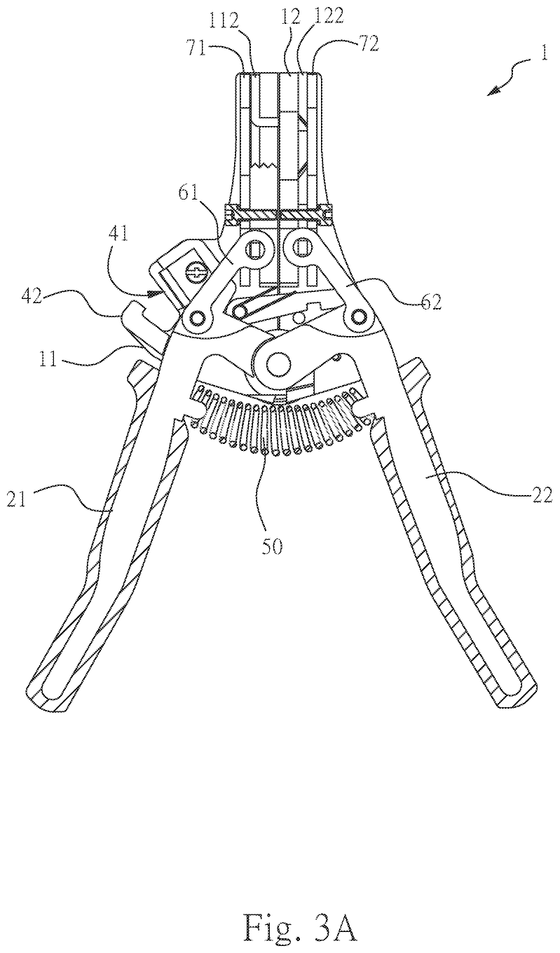

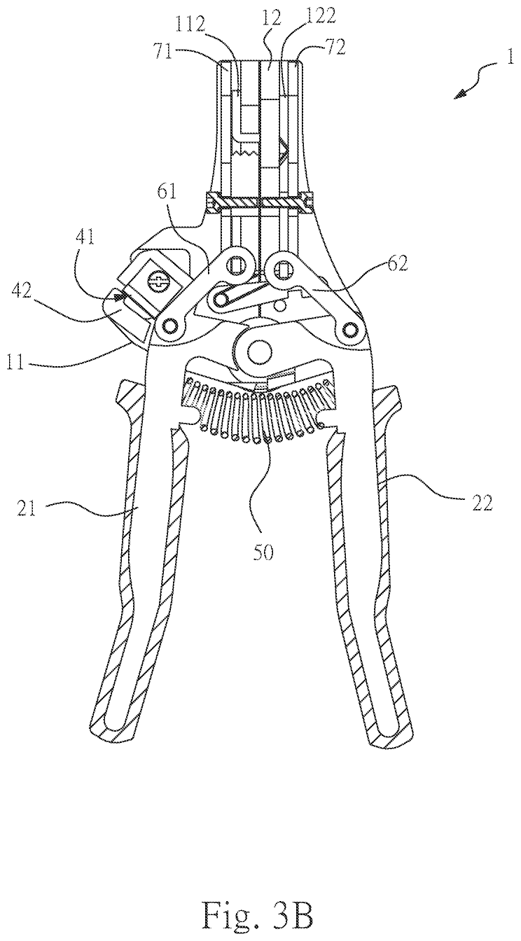

Now please refer to FIGS. 3A and 3B, which illustrate schematic diagrams of the continuous motion of the hand tool with a cutting function of the present invention.

From the continuous actions illustrated in FIGS. 3A and 3B, it can be understood that when the first plier 21 and the second plier 22 are pressed, the blade 41 Till also move. At this time, the knife drill 42 on the first body 11 will not move, and the blade 41 will approach the knife drill 42 to achieve the cutting function.

The hand tool 1 with a cutting function of the present invention to also has a stripping function. Therefore, the hand tool 1 further comprises a first clamping piece 112, a second clamping piece 122, a first link 61, a second link 62, a first shutter 71, and a second shutter 72.

The first clamping piece 112 corresponds to the first jaw section 111 of the first body 11. In addition, the shape of the first clamping piece 112 also corresponds to the serrated surface of the first jaw section 111. The second clamping piece 122 corresponds to the second jaw section 121 of the second body 12. The second clamping piece 122 can also include a serrated blade.

The first link 61 and the second link 62 are symmetrically arranged. The two ends of the first link 61 are pivoted to the first plier 21 and the first clamping piece 112 separately, and the two ends of the second link 62 are pivoted to the second plier 22 and the second clamping piece 122 separately. Thus, when the user compresses the first plier 21 and second plier 22, the first clamping piece 112 will be driven by the first link 61 to move downwards, and the second clamping piece 122 will be driven by the second link 62 to move downwards.

The first shutter 71 and the second shutter 72 are symmetrically arranged. The first shutter 71 is fixed at the first body 11 to cover the first clamping piece 112 such that the first clamping piece 112 can be moved between the first shutter 71 and the first body 11 by the first link 61. The second shutter 72 is fixed at the second body 12 to cover the second clamping piece 122 such that the second clamping piece 122 can be moved between the second shutter 72 and the second body 12 by the second link 62. The first shutter 71 is provided with a first cut groove 711, and the first cut groove 711 corresponds to the first jaw section 111. The second shutter 72 is provided with a second cut groove 721, and the second cut groove 721 corresponds to the second jaw section 121,

In this way, when a wire is put into the first jaw section 111 and the second jaw section 121 and then the first plier 21 and the second plier 22 are held closed, the first clamping piece 112 is driven by the first link 61 to move downward to clamp the wire. The second clamping piece 122 is simultaneously driven by the second link 62 to approach the serrated blade such that the serrated blade will cut an insulation layer of the wire but avoid cutting a core wire in the wire.

In addition to the above-mentioned elements, the hand tool 1 with a cutting function of the present invention may also include other elements. Since the technology of other elements is not the focus of the present invention, it will not be further described here. Moreover, the present invention is not limited to the embodiments of the above-mentioned. hand tool 1.

It can be seen from the above description that the hand tool 1 of the present invention have both wire stripping and cutting functions at the same time, eliminating the need for the user to carry both a wire stripper and scissors at the same time and thereby helping the user by providing convenience of transportation and operation.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A hand tool with a cutting function, used for cutting a wire, the hand tool with the cutting function comprising:
a first body;
a second body, arranged symmetrically with the first body;
a first plier;
a second plier, arranged symmetrically with the first plier;
a pivoting piece, simultaneously pivotally connected to the first body, the second body, the first plier, and the second plier;
a blade; and
a knife drill, arranged corresponding to the blade, the blade and the knife drill being respectively arranged on the first body or the first plier,
wherein when the first plier and the second plier are pressed, the blade approaches the knife drill so as to cut the wire.

2. The hand tool with the cutting function as claimed in claim 1, wherein the blade is arranged on an outside of the first plier and the knife drill is located on the first body.

3. The hand tool with the cutting function as claimed in claim 1, wherein the blade is arranged on the first body and the knife drill is located on an outside of the first plier.

4. The hand tool with the cutting function as claimed in claim 1, further comprising a compression spring, wherein one end of the compression spring is connected to the first plier and the other end of the compression spring is connected to the second plier.

5. The hand tool with the cutting function as claimed in claim 1, wherein the first body has a first jaw section and the second body has a second jaw section, and the first jaw section corresponds to the second jaw section.

6. The hand tool with the cutting function as claimed in claim 5, further comprising:
a first clamping piece, arranged corresponding to the first jaw section;
a second clamping piece, arranged corresponding to the second jaw section, a shape of the first clamping piece corresponding to a shape of the second clamping piece;
a first link, respectively pivotally connected to the first plier and the first clamping piece; and
a second link, respectively pivotally connected to the second plier and the second clamping piece, a shape of the first link corresponding to a shape of the second link.

7. The hand tool with the crating function as claimed in claim 6, further comprising:
a first shutter, fixed to the first body to cover the first clamping piece, and
a second shutter, fixed to the second body to cover the second clamping piece, a shape of the first shutter corresponding to a shape of the second shutter.

8. The hand tool with the cutting function as claimed in Claim wherein the first shutter has a first cut groove arranged corresponding to the first jaw section and the second shutter has a second cut groove arranged corresponding to the second jaw section.
